(19) United States
(12) Patent Application Publication
(10) Pub. No.: US 2006/0209006 A1
(43) Pub. Date: Sep. 21, 2006

(54) LCD display module

(75) Inventor: Wolfgang Eckhardt, Weingarten (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT

(21) Appl. No.: 11/378,102

(22) Filed: Mar. 17, 2006

(30) Foreign Application Priority Data
Mar. 18, 2005 (DE) 10 2005 012 627.8

(51) Int. Cl. G09G 3/36

(52) U.S. Cl. 345/102

(57) ABSTRACT

An LCD display module with a backlight is proposed, of which the light backlights an LCD display of the LCD display module. The fact that the backlight is arranged between a circuit board and the LCD display, the circuit board is equipped with white LEDs or OLED segments which are essentially arranged in the form of a matrix, and the brightness of the relevant LED or OLED is able to be controlled allows an essentially even brightness distribution on the LCD display to be produced.

### CROSS REFERENCE TO RELATED APPLICATIONS

This application claims priority to the German application No. 10 2005 012 627.8, filed Mar. 18, 2005 which is incorporated by reference herein in its entirety.

### FIELD OF INVENTION

The invention relates to an LCD display module with a backlight, the light of which backlights an LCD display of the LCD display module.

### BACKGROUND OF INVENTION

Usually a backlight which generates white light is used for backlighting of an LCD display module for a flat screen display. The light radiates in all directions in the display module, with a reflector being provided to reflect the light radiated backwards towards the LCD display. This type of flat screen can be used in particular in the medical area, in which high contrast as well as even brightness distribution when displaying images is required.

### SUMMARY OF INVENTION

An object of the present invention is to specify an LCD display module of the type specified above which allows an essentially even luminance distribution on an LCD display of a display module.

This object is achieved by
the backlight being arranged between a circuit board and the LCD display,
the circuit board being provided with white light emitting diodes or organic light emitting diode segments which are essentially arranged in the form of matrix,
the luminance of the relevant light emitting diode or the relevant light emitting diode segment being able to be controlled.

The invention is based on the idea of replacing a “passive reflector” known per se and regularly present in LCD display modules by an “active” medium. The luminance distribution is simple to set, with the luminance distribution of a white image initially being recorded with a camera or with a suitable luminance measurement device during a calibration phase. Subsequently the dark points on the LCD display can be illuminated additionally by a corresponding activation of the light emitting diodes or of the light emitting diode segments, which has the effect of essentially distributing the brightness evenly on the LCD display.

### BRIEF DESCRIPTION OF THE DRAWINGS

With reference to the drawing, in which an exemplary embodiment of the invention is illustrated, the invention, its embodiments and also its advantages are explained in more detail below.

The figures show:

FIG. 1 a schematic diagram of an arrangement with an LCD display module,

FIG. 2 a circuit board equipped, with LEDs and

FIG. 3 an arrangement with an LCD display module and an imaging device.

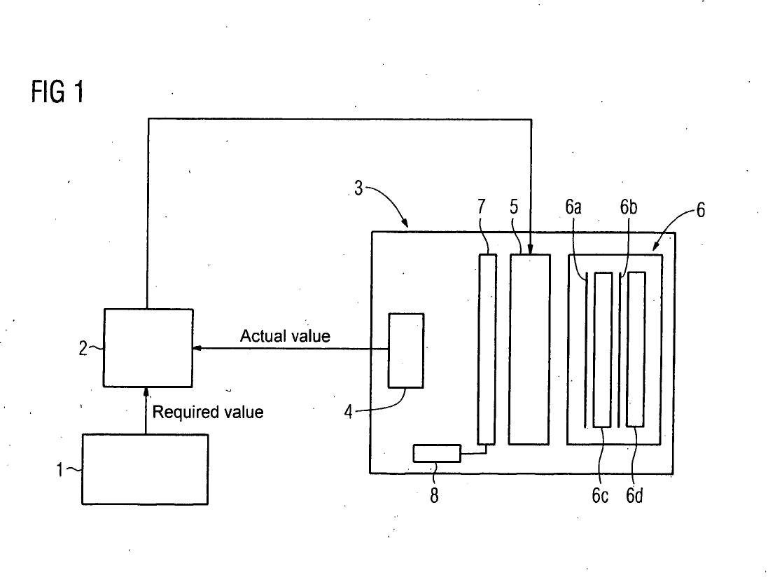

The same parts in FIGS. 1 to 3 are labeled with the same reference symbols.

### DETAILED DESCRIPTION OF THE DRAWINGS

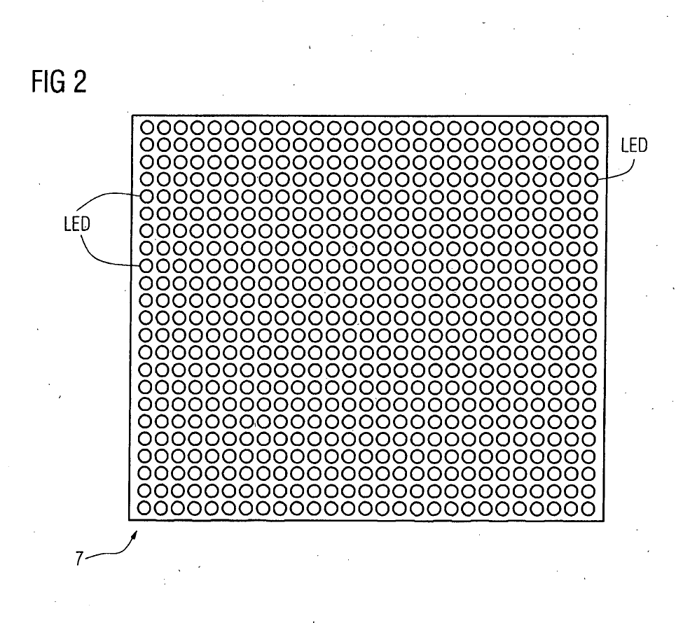

In FIG. 1 the number 1 designates a graphics processor which supplies a backlight regulator 2 of an LCD display module 3 with a predetermined required value corresponding to a required luminance. Through an opening of an LCD circuit board 7 a sensor 4 records the luminance of a backlight 5 and also transfers an actual value corresponding to this recorded luminance to the backlight regulator 2, with this backlight regulator 2 adjusting the intensity of the white light of the backlight 5 in accordance to how far the actual value deviates from the required value. The light of the backlight 5 backlights an LCD display 6, which essentially comprises diffuser and/or polarization foils 6a, 6b as well as LCD glass and LCD fluid 6c, 6d. In order to achieve an essentially even luminance distribution of a white image shown on the LCD display 6, the circuit board 7 features light emitting diodes or organic light emitting diode segments arranged in the form of a matrix (FIG. 2) (referred to as LEDs below) with each of these LEDs being able to be activated via a suitable activation unit 8 (FIG. 1). Correspondingly activated LEDs, by contrast with a conventional LCD display module, cause areas of the white image which are too dark to be displayed more brightly. For the case in which the darkest areas of an LCD display module 3 without the LED activation have a luminance value of e.g. 280 cd/m² and the brightest area has a luminance value of for example 300 cd/m², the activated LEDs increase the darkest areas to the luminance value of 300 cd/m². This achieves a white image with an essentially even luminance distribution of 300 cd/m².

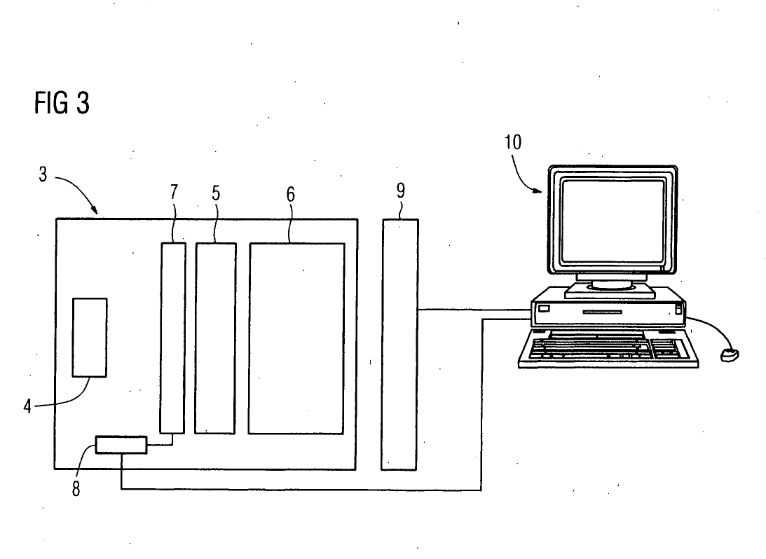

To activate the LEDs accordingly, the luminance distribution of a white image displayed on the LCD display 6 is initially captured with an imaging device 9 and recorded (FIG. 3), which ensures that the ambient brightness does not have an adverse effect on the capturing of the luminance distribution. The luminances recorded are processed by a personal computer 10 such that a program which can be run on the personal computer 10 initially determines the point in the image with the maximum luminance. Subsequently the program determines correction values for each point in the image which are a measure for the activation of the LEDs corresponding to the points and thereby a measure for the luminances of these LEDs to be set. For example it is necessary to increase the luminances of some points of the white image by 30 cd/m², but only to increase the luminances of other points by 25 cd/m², in order to achieve an essentially even luminance of 300 cd/m² for all points of the white image. The personal computer 10 transfers the correction values over a suitable interface to the activation unit 8, with the activation unit 8 storing the correction values and creating from these values corresponding voltages for activation of the LEDs. The correction values remain stored in the activation unit 8 during a normal mode of operation of the LCD display module until a new distribution of the light emitting diodes is recorded and new correction values are calculated and transferred to the activation unit 8.

1. (canceled)

2. An LCD display module, comprising:
a circuit board;
an LCD display; and
a backlight configured to emit light for backlighting the LCD display, wherein
the backlight is arranged between the circuit board and the LCD display,
the circuit board comprises a plurality of white light emitting diodes or organic light emitting diode segments arranged as a diode matrix, and
the white light emitting diodes respectively the organic light emitting diode segments are configured to be controlled regarding their luminance.
